(19) United States
(12) Patent Application Publication
(10) Pub. No.: US 2020/0027006 A1
(43) Pub. Date: Jan. 23, 2020

(54) SYSTEM AND METHOD FOR HIERARCHICAL METRIC TEMPORAL PLANNING AND RE-PLANNING

(71) Applicant: Knexus Research Corporation, Oxon Hill, MD (US)

(72) Inventors: Kalyan Moy Gupta, Springfield, VA (US); Son Thanh To, Vienna, VA (US)

(21) Appl. No.: 16/042,687

(22) Filed: Jul. 23, 2018

(51) Int. Cl. G06N 5/02; G06N 5/00

(52) U.S. Cl. CPC G06N 5/02; G06N 5/003

(57) ABSTRACT

Advanced systems and methods for temporal planning employ a temporal logic for representing and reasoning about temporal constraints over both logic and numeric (discrete and continuous) variables and continuous time. A temporal planning language represents a world model, and adapts the temporal planning language to support formulas expressing the temporal logic. Embodiments of the present disclosure also can receive a temporal planning problem and derive one or more solutions to the temporal planning problem using one or more of the formulas. Embodiments of the present disclosure further address re-planning such as, for example, when a new objective task is added to the set of objective tasks to be performed, when an existing objective task is cancelled, and/or when some event occurs unpredictably and invalidates the current plan.

### STATEMENT REGARDING FEDERALLY SPONSORED RESEARCH OR DEVELOPMENT

The disclosed invention may be manufactured and used by or for the government of the United States of America for governmental purposes without the payment of any royalties thereon or therefor.

### TECHNICAL FIELD

The present disclosure relates to computer-facilitated artificial intelligence planning, and more particularly to systems and methods for temporal planning.

### BACKGROUND

Automated planning and scheduling, sometimes also called AI Planning, is a branch of artificial intelligence that concerns the realization of strategies or action sequences, typically for execution by intelligent agents, autonomous robots and unmanned vehicles. In AI planning, the world is modeled by a set of variables and a world state denoting an assignment of values to the variables. An action specifies how a world state changes under certain conditions (precondition). Typically, a planning problem is defined by a set of variables V, an initial state I specifying the initial values of the variables, a set of actions A, and a goal G. The objective of the problem is to find action sequences that transit the initial state Ito a goal state, i.e., a state that satisfies the goal G.

Temporal planning (TP) concerns numeric (both discrete and continuous) variables (vs binary variables or predicates), continuous (vs discrete) time, durative (vs instantaneous) actions with both discrete and continuous changes, and temporal constraints. Due to these features, temporal planning is used in many practical applications such as robotics, logistics, autonomous spacecraft, and manufacturing, where continuous resources and exact real time constraints matter. One of the best known, efficient approaches to AI planning used in many state-of-the-art planning systems is to use forward search in the state space for planning solutions with the guidance of heuristics, i.e., the search prefers states with the best heuristic value. However, this approach is not good enough for temporal planning as temporal planning is, in general, undecidable (i.e., by reference to computability theory) due to continuous temporal constraints and continuous variables.

An alternative, more realistic and efficient approach to temporal planning is to use application domain knowledge and expertise about combinations and dependency among actions in the form of hierarchically structured networks, called hierarchical task networks (HTN). Specifically, application domain knowledge and expertise are given in the form of methods, which specify how a task can be decomposed and performed by smaller component sub-tasks with ordered constraints among these sub-tasks. If the decomposition of a task fails because the temporal constraint is violated or its execution condition is not satisfied, then the search backtracks to an alternative decomposition scheme for the task or its closest ancestor for which an alternative method or action instance unifies. The search terminates with no solution if no such alternative decomposition scheme exists. This decomposition process is successfully completed when all these tasks in the network have been decomposed into primitive tasks that can be performed directly by an executable action and that need not be decomposed further. In an HTN planning problem, objective tasks that need to be accomplished are given, instead of goals. Thus, a HTN planning problem is given by a set of methods and actions, an initial state and a network of objective tasks, called the initial task network. A solution to an HTN planning problem is sequences of actions that correspond to the primitive tasks in the network obtained by the decomposition. Due to knowledge given in hierarchically structured networks, HTN planning is substantially more efficient than non-HTN planning, as the search in HTN planning is limited to the possible paths given in the network (methods) instead of considering all the possible paths, i.e., all possible actions that lead from a state to another.

HTN temporal planning is promising but faces several challenges. For example, planners such as SHOP2_{PDDL+} may support nonlinear continuous effects, but cannot handle accumulative effects of parallel actions. Further, temporal planners such as FAPE that support limited HTN (i.e., a simple non-recursive structure of actions) use backward search in the plan space of partial order by causal links for solutions, which prevents these planners from dealing with continuous time and continuous variables. Additionally, planners such as GSCCB-SHOP2, which is an extension of the SHOP2 HTN temporal planner, incorporate a simple temporal network (STN) for checking consistency of temporal constraints. This approach supports continuous time and numeric variables but not continuous variables and continuous changes, which are important in temporal planning. Furthermore, in this approach, the time points for action effects and temporal constraints are limited to the start and end times of actions.

Among other things, the current approaches and temporal planners have inherent difficulties/inability for: (1) planning with continuous variables/resources/changes for continuous time, especially for the plan-space approaches (e.g., FAPE, GSCCB-SHOP2) due to the late commitment that makes the evaluation of constraints over numeric variables extremely challenging if possible, (2) handling parallel actions that produce overlapped effects on the same variables, which is inherent difficulty for HTN planning due to non-linear sequences of actions in different layers in the network, and (3) expressing and reasoning about complex temporal constraints. Such complex constraints may include, for example, (a) temporal constraints over discrete and continuous variables and continuous time, (b) temporal constraints over time points other than start/end points of actions and for time periods other than action durations, and/or (c) high order temporal constraints that require multiple nested time variables.

### SUMMARY

To address the above issues, various embodiments of the present disclosure provide advanced systems and methods for temporal planning. In various embodiments, the present disclosure describes creating a temporal logic called Mixed Propositional Metric Temporal Logic (MPMTL). MPMTL is a temporal logic for representing and reasoning about temporal constraints over both logic and numeric (discrete and continuous) variables and continuous time. Specifically, variable values over time are represented by a timeline and world model is a set of timelines for all variables in the planning problem. MPMTL is used to represent and reason about temporal planning. Embodiments of the present disclosure further establish a temporal planning language to represent a world model, and adapt the temporal planning language to support formulas expressing the temporal logic. Embodiments of the present disclosure also can receive a temporal planning problem and derive one or more solutions to the temporal planning problem. Embodiments of the present disclosure further address re-planning.

### BRIEF DESCRIPTION OF THE DRAWINGS

FIG. 1 is an exemplary system diagram of embodiments of the present disclosure.

FIG. 2 shows a diagram illustrating exemplary planner processes in accordance with aspects of the present disclosure.

FIG. 3 shows an exemplary heuristic forward search in the continuous model space implemented in accordance with aspects of the present disclosure.

FIG. 4 shows an exemplary heuristic AND/OR search for decomposition implemented in accordance with HMTP temporal planner embodiments of the present disclosure.

FIG. 5 is an exemplary high level replanning flow diagram in accordance with aspects of the present disclosure.

FIG. 6 is a diagram illustrating a validity check of an input problem in accordance with aspects of the present disclosure.

FIG. 7 is a flow diagram illustrating a method in accordance with the present disclosure.

FIG. 8 is a diagram illustrating an example problem in accordance with the present disclosure.

### DETAILED DESCRIPTION OF THE PREFERRED EMBODIMENTS

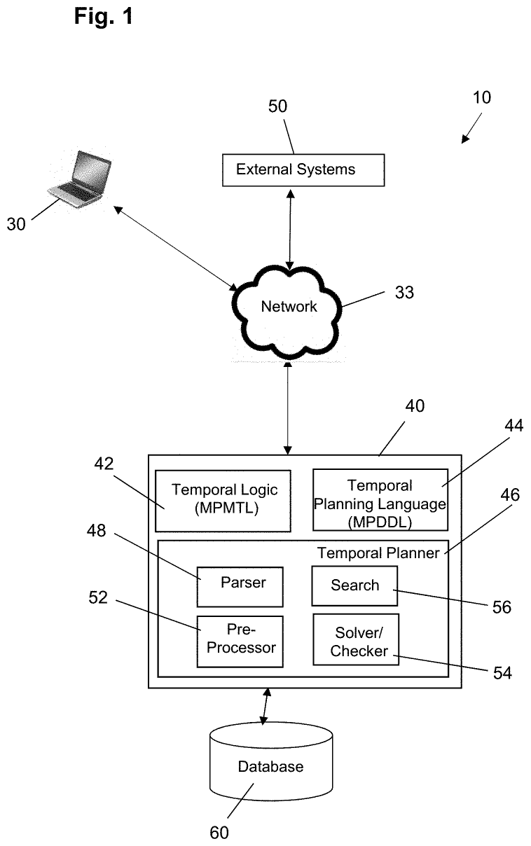

FIG. 1 shows an exemplary system 10 according to embodiments of the present disclosure. The exemplary system 10 shows a user interface 30. The user interface 30 can be provided as a desktop computer, laptop computer, tablet, mobile communications device (MCD) or similar computing device, for example. Regardless of form factor, the user interface 30 can incorporate necessary processing power and memory for storing data and programming that can be employed by the processor(s) to carry out the functions and communications necessary to facilitate the processes and functionalities described herein. Each user interface or client computing device 30 can be configured to communicate with a host controller 40 that hosts components of the system described herein.

The user interface 30 allows users to interact with the system of the present disclosure, enter and receive inputs, and receive reports, plans and other solutions, for example. While the user interface 30 can receive manually entered data, it will be appreciated that external elements and systems 50 can communicate data to host controller 40, in automated or manual fashion. As further shown in FIG. 1, host controller 40 can include components that automate and/or assist with analyzing problems and developing solutions using the temporal planner. Such components can include temporal logic component 42, which can also be called MPMTL component herein, temporal planning language component 44, which can also be called MPDDL component herein, and temporal planner component 46. The temporal planner component 46 can be an MTP planner or HMTP planner depending upon the embodiment, as disclosed herein. As illustrated in FIG. 1, the temporal planner component 46 can include sub-components, such as parser 48, pre-processor 52, solver/checker 54, and search sub-component 56. As described elsewhere herein, the parser 48 can read and parse received temporal planning problems, which may be provided in multiple files according to various embodiments, including a domain file and a problem instance file, for example. The file(s) can be provided in the temporal planning language MPDDL in accordance with various aspects of the present disclosure. The pre-processor component 52 checks the consistency of the defined problem, by evaluating action conditions, constraints, the initial model and goal(s), to ensure that those components of the received problem are valid and consistent. For example, the pre-processor component 52 uses the solver/checker subcomponent 54 as a solver to check whether both the initial constraints and goals are satisfiable. If not, then the received problem is inconsistent and the planner will report accordingly. In various embodiments, the pre-processor component 52 can also simplify the defined problem by reducing or eliminating redundant variables and actions, for example. If the solver/checker subcomponent 54 finds out that action conditions are not satisfiable, for example, then the corresponding actions will be eliminated. The search component 56 uses the solver/checker subcomponent 54 as a model checker to verify the satisfaction of action conditions, constraints, and the goal in a world model.

The search sub-component 56 executes one or more search algorithms as part of finding a solution for the defined problem. A search algorithm is associated with a search graph, consisting of nodes (vertex) and edges. In planning, nodes often represent states of the world and edges represent actions that transit from states to states. In a classical planning problem, the initial state, set of actions, and goal are given. The search is to expand the nodes (states) on the search graph to their neighbors using the given actions as the transit. The search starts with the initial state and produces a solution when it reaches a node that satisfies the goal. The search terminates when a solution is found, there is no more unexplored node left, or it is timed out. In planning, the decision on how to expand the search graph or what state to be explored next is usually based on a heuristic function that typically represents the estimated distance from a node to the goal (a goal node). Specifically, the unexplored node with the best heuristic value is chosen to be explored next each time.

There are two main search topologies used in planning. First, the “OR” search is used most often in planning, usually mentioned by depth-first-search, breadth-first-search, and heuristic search. The “OR” search reaches the goal when a goal node is detected, i.e., a linear path/sequence of actions from the start node to a goal node is established. More specifically, from a node in the search graph, if one transition leads to a goal node then the search reaches a solution, i.e., all the neighbors of a node are disjunctive related (OR). Alternatively, the “AND/OR” search is used when multiple branches from a node need to reach the goal altogether (conjunctive or AND related). AND/OR search is a well-known approach in contingent planning, where a state (node) can lead to different states with the same transition action, depending on the satisfaction of the conditions in the state during the execution time and it is not known in the planning time because of incomplete information in contingent planning. In this case, all such branches need to reach the goal, i.e., no matter which conditions will be satisfied during the execution time, the plan will be executable and achieve the goal. Such a node is called an AND node. The AND/OR search graph also consists of the OR node that represents the alternative transitions as for the OR search. We say that a node reaches the goal if: (1) it is a goal node, (2) it is an OR node and it has at least a child that reaches the goal, or (3) it is an AND node and each of its children reaches the goal. A solution is reached in AND/OR search if the start node reaches the goal, when the search graph consists of a subgraph, called solution graph, such that: (1) it consists of the start node, (2) each leaf node in the solution graph is a goal node, and (3) each of nodes in the solution graph reaches the goal.

In accordance with the present disclosure, an AND/OR search is created for the decomposition in HTN planning for solutions, in which an AND node represents a set of tasks to be performed altogether, a method instance that unifies with a task represents a transition (i.e., a possible decomposition of the task to smaller tasks), and a primitive task that can be performed directly by an action is a leaf node. A task that unifies with multiple alternative method instances is an OR node.

As further shown in FIG. 1, external services 50 can be incorporated, including a learner component, for example, wherein developed solutions and/or plans can be compiled in a database with facts necessary for training. Such a database can be part of database 60 described elsewhere herein, or a separate database. It will be appreciated that the above components and/or subcomponents can be provided as independent and/or interoperable software components in various embodiments of the present disclosure. As further shown in FIG. 1, data storage 60 can comprise an internal store of information related to the ongoing planning, as well as knowledge necessary to perform reasoning activities. In embodiments, the present disclosure's memory can store models for problem formulation, task decomposition, goal formulation, assumptions, and historical lessons learned, for example, in addition to situation data, temporal data and knowledge artifacts representing expert knowledge about a given domain. Such models can be provided as independent and/or interoperable software components in various embodiments of the present disclosure.

Among other things, MPMTL component 42 is used in accordance with the present disclosure to represent temporal constraints, conditions, and goals in temporal planning, thereby addressing issues associated with plan-space approaches and complex temporal constraints. The timeline introduced in MPMTL is used to represent the world continuously and completely over time horizon. This allows for representing and reasoning about overlapped, mixed discrete and continuous changes at any time point and for any time period, thereby addressing parallel actions that produce overlapped effects on the same variables as described above. Embodiments of the present disclosure further extend planning domain description language (PDDL), the standard planning language, to MPDDL to support MPMTL for use in temporal planning. An MPMTL-based Temporal Planner (MTP) and a hierarchical version of MTP (HMTP) are disclosed herein. Temporal planner component 46 in FIG. 1 represents one or the other version, depending upon the implementation. The hierarchical version of MTP (HMTP) supports HTN.

As disclosed herein, the planner component 46 employs the created MPMTL temporal logic 42, which allows the planner 46 to support high order temporal constraints/conditions of both discrete and continuous variables, and uses world model (timelines) to represent the world continuously. As a consequence, the temporal planner component 46 can update the world at any time and for any interval for both discrete and continuous changes. In various embodiments, the MTP temporal planner, which is a version of temporal planner 46, also uses forward search in the continuous world model space with heuristic for interval, quantitative goals, dynamic discretization, and pruning technique for solutions.

To support MPMTL in temporal planning, embodiments of the present disclosure provide temporal planning language component 44 providing a language (MPDDL) with new capabilities. For example, MPDDL can express complex temporal constraints/conditions, such as (a) high order temporal constraints, which are those that contain multiple nested modalities, and (b) action conditions/effects at time points other than the start/end time points and for intervals other than the action duration. MPDDL according to the present disclosure can also express the initial world model (timelines). For example, the fuel level of an airplane is equal to ten at time 0 and it is decreasing with the rate 2 until time point 4 when it becomes 2. Then this value remains until infinity. MPDDL according to the present disclosure can also express world model (temporal) constraints for all subsequent world models during planning, and can address complex functions such as those that are defined over other functions/variables. For example, the variable flying time of an airplane from point A to point B is defined over variables distance and speed and it is equal to the division of distance by speed. MPDDL according to the present disclosure can also express formulas, both prefix and infix, whereas PDDL supports only prefix. In various embodiments, the input for a problem in MPDDL can be given in two files, such as text-formatted files, for example. As described elsewhere herein, one of the files describes the domain of the problem and the other file specifies the problem instance. More specifically, the domain file defines the general features for the class of the problem, including object types (e.g., airplane, car, etc.), variable schemas (predicates and numeric functions), and actions. The problem file specifies the specific details of the problem instance, including object instances (e.g., car1, car2, etc.), variable values, objective goals, and problem temporal constraints. The temporal planning language component 44 can produce and/or apply the MPDDL language according to aspects of the present disclosure. The MPDDL language may optionally be stored in database 60.

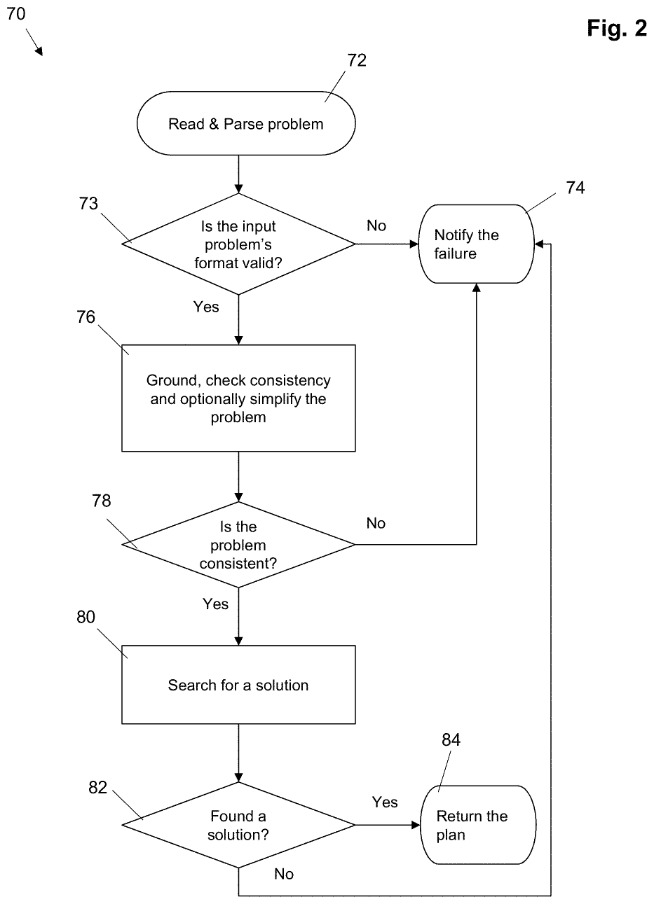

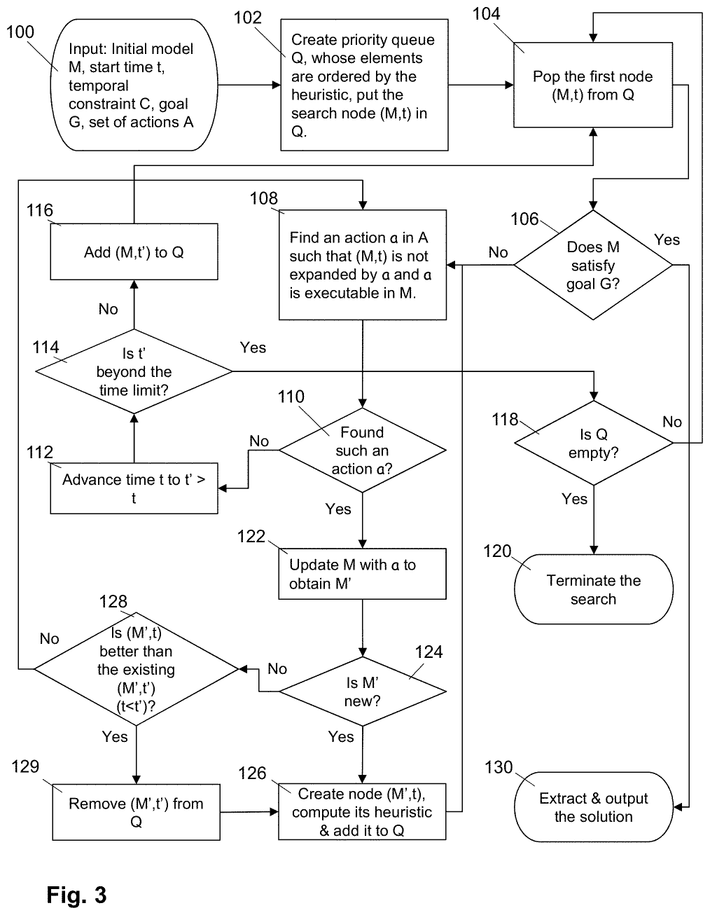

FIG. 2 illustrates operations of the temporal planner component 46 in accordance with aspects of the present disclosure. As shown at step 72 in the diagram 70, the temporal planner component 46 reads and parses a received temporal planning problem. In various embodiments, this function is performed by parser sub-component 48. As described elsewhere herein, the problem can be defined according to two files in the MPDDL language, wherein a first file is the domain file and the second file is the problem instance file. As at step 73, the received problem is evaluated, such as by parser sub-component 48, to determine if its format is valid. If not, the process notifies the system and/or controller 40 of the failure, as at step 74. If the problem's format is valid, then at step 76, the problem pre-processor sub-component 52 performs grounding, consistency checking and preprocessing to eliminate redundant/irrelevant variables and actions. If the problem is not deemed consistent with specified requirements such that the conditions, goals and/or constraints in actions are not satisfiable as at 78, then the system and/or controller 40 is notified of the failure as at step 74. On the other hand, if the problem is deemed consistent, the system operates to search for a solution as at step 80. Search sub-component 56 and a relevant search algorithm can be employed for this process, as illustrated and described in connection with FIG. 3, for example. In various embodiments, the solver/checker sub-component 54 operates to implement the appropriate search algorithm via search sub-component 56, and further operates to direct the model checker implemented by pre-processor sub-component 52. Regardless, the system then assesses whether a solution is or can be found, as at 82, and if so, the temporal plan representing the solution is returned as at 84. If not, then the system and/or controller 40 is notified of the failure as at step 74.

In various embodiments, the temporal planner component 46, or more specifically, the MTP version of the temporal planner component 46, implements a heuristic forward search in the model space. It employs time discretization for the search with a pruning technique in the continuous model space. In various embodiments, the discretization step can be computed by the expression C*D/N², i.e., dynamically based on the average action duration (D) and the number of actions (N) and a constant C as a parameter for the problem. Each node in the search graph represents a timestamped world model. The search starts with the start node, that represents the initial model, at the start time. From each node that has not been explored, the search tree is expanded to the neighbor nodes by actions, where each action is applied at the node (in the model at the time) at most once.

In various embodiments, the pruning technique is based on the deadline of goals, which can be computed from the temporal constraints for the goals or it is infinity for those that do not have such constraints. Specifically, if the current time passes the deadline of a goal that has not been achieved yet, then the search node is discarded. Furthermore, if two nodes are similar then only the one with the better heuristic value is retained in the search graph.

An example of this process is shown in FIG. 3, where at 100, the search sub-component (56 in FIG. 1) receives as input the initial model M, the start time t, at least one temporal constraint C, at least one goal G, and a set of actions A. The “set” of actions A can be a single action in accordance with various embodiments. As at 102, a priority queue Q is created, wherein the queue's elements can be ordered by the heuristic, and the search node (M, t) is placed into Q. As at 104, the first node (M, t) is popped from Q. As at 106, the determination is made as to whether the model M satisfies the goal G. If so, then at 130, the solution is extracted and reported. If not, then at 108, an action α is found in A such that (M, t) is not expanded by α and α is executable in M. A determination is then made at 110 as to whether such an a is found. If not, then the time t is advanced to a time t′ that is greater than t (i.e., at a later time than t) as at 112, and a determination is made as at 114 as to whether t′ is beyond the time limit specified. If not, then the search node (M, t′) is added to Q as at 116, and the process returns to step 104, where the next node is popped and the relevant processes continue. If t′ is beyond the time limit specified, then as at 118, the system determines if Q is empty. If not, the operation proceeds back to step 104 and the next node is popped for further processing. If the Q is determined to be empty at 118, then as at 120, the search is terminated.

Returning to step 110, if an action α is found such that (M, t) is not expanded by α and α is executable in M, then as at 122, M is updated with a to M′. Then, M′ is evaluated to determine if M′ is new as at 124. If so, then at 126, a new node (M′, t) is created, its heuristic is computed, it is added to Q and the process returns to 108. If M′ is not new, then a determination is made as at 128 as to whether (M′, t) is better than the existing (M′, t′) where t is earlier than t′. If so, then (M′, t′) is removed from the queue Q as at 129, and the process returns to 126. If not, then the process returns to 108.

Thus, as can be seen, the implementation of the search algorithm illustrated in FIG. 3 uses a priority queue for unexplored search nodes. The ordering function for nodes in this queue can be implemented based on the heuristic described in the algorithm. This assures the node with the best heuristic is always on the top of the queue and will be popped out first each time for the search exploration.

It will be appreciated that interval and quantitative goals specify a process rather than an instant fact as considered in most other approaches. For example, a partial plan that maintains a longer relay should be considered better than those with a shorter relay, even though none of them yet achieves the complete goal. In various embodiments of the present disclosure, the heuristic value is an increasing function of the duration, in which an interval goal has been partially achieved in the model, and of the value for a quantitative goal achieved so far in the model. If two search nodes have the same heuristic value, then the search will favor the node with the smaller timestamp t.

In various embodiments, the temporal planner component 46 can be implemented in the C++ coding language, and as described above, can include an MPDDL parser component 48 that can read planning problems described in the MPDDL language. The Solver/Checker sub-component 54 can be used as a solver to check whether the goal and the initial constraint of the problem are satisfiable, while the model checker can be used to verify the satisfaction of action conditions, constraints, and the goal in a world model. In various embodiments, both can be done in polynomial time.

In various embodiments, the HMTP planner version of the temporal planner component 46 is a variant of the MTP planner, wherein the HMTP planner supports HTN. HMTP can employ the MPMTL temporal logic that allows the planner to support high order temporal constraints/conditions of both discrete and continuous variables. HMTP further can use world model (timelines) to represent the world continuously. As a consequence, HMTP can update, keep track of, and reason about the world with both discrete and continuous changes at any layer of the hierarchical task network without the use of such techniques as linear programming or simple temporal network, that complicate and slow down the search. HMTP further can use AND/OR forward search in the continuous world model space as HTN decomposition for solutions. This search algorithm/decomposition allows the planner to scale up and produce multiple solutions for the same problem as when a solution is found, the search continues the decomposition with another alternative node in the search graph. Other HTN planners employs either a recursive decomposition or an AND-search for solutions.

In various embodiments, to support HTN, MPDDL used in MTP is extended for specifying methods, objective tasks, and the temporal constraints between tasks. Methods and temporal constraints between methods are defined in the domain file, while objective tasks and the temporal constraints are specified in the problem file. For a better scalability, an AND/OR forward search in the continuous model space can be implemented, instead of a recursive decomposition algorithm usually used in other HTN planners, for the HMTP planner. A node that represents a primitive task which can be performed directly by an action is called a terminal node. Thus, a terminal node, like a goal node, is always a leaf node in the search graph. In this specific AND/OR search, a node is associated with a world model, a set of temporal constraints, and a single task or set of tasks to be performed. If these tasks must be performed all together (conjunctive) then the node is an AND-node. Otherwise, if the tasks are alternatives (disjunctive), i.e., only one of them is required to be performed then the node is an OR-node. The start node represents the initial model, initial temporal constraint, and the (set of) objective task(s). An edge represents a unifiable method instance or action for the task. The objective of this AND/OR search is to expand the AND/OR search graph, started from the start node, by matching the tasks with method instances or actions to reach solutions. The search terminates when no more unexpanded node is left, the maximum number of solutions is found, or the time-out limit is reached. Temporal constraints at a parent node will be passed to its children and if the set of temporal constraints at a node is inconsistent, then the node is invalid and will be discarded.

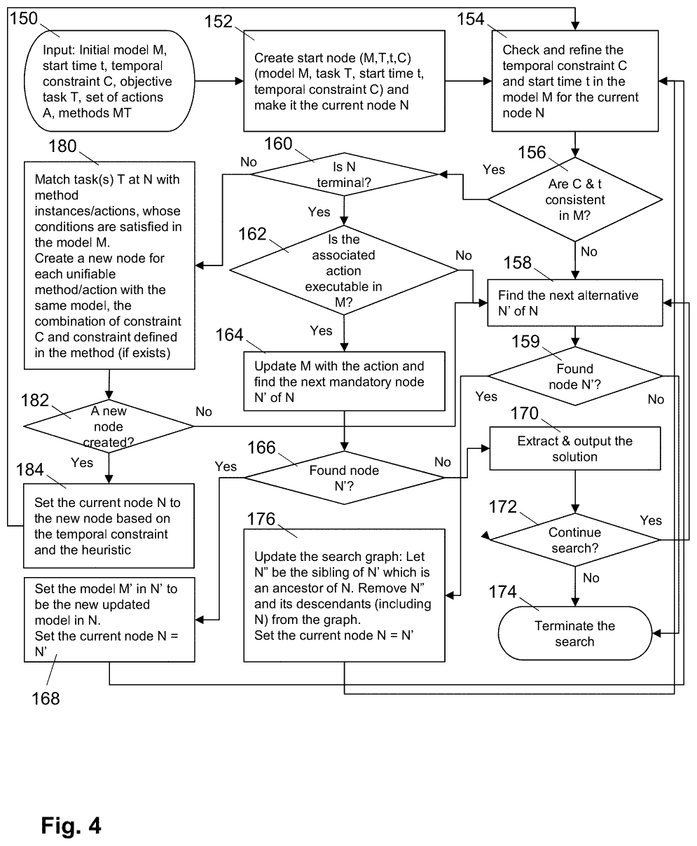

The search algorithm for decomposition in the HMTP planner component in accordance with various embodiments is detailed as shown in FIG. 4. As shown at 150, the input includes initial model M, start time t, temporal constraint C, objective task T, set of actions A and methods MT. As at 152, the starting root node N represents the initial world model M, the set of objective tasks T to be decomposed into smaller tasks and eventually primitive tasks to be performed directly by actions, the start time t and the temporal constraint C. As at 154, when a node is explored, the temporal constraint C and start time t are checked and refined in the model M for the current node N. A determination is made, as at 156, whether constraint C and time t are consistent in model M. If the temporal constraints are inconsistent or the conditions are not satisfied in the current model, then the system seeks the next alternative node (backtracking) to explore, as at 158. Checking conditions against a model can be repeated with the advancement of a defined time step until the conditions are met or the temporal constraints are violated (e.g., the current time exceeds the maximum time allowed). On the other hand, if the determination in 156 is true, then as at 160, the node N is evaluated to determine if it is a terminal node. If so, then a determination is made as at 162 as to whether the associated action is executable by the model M. If the node is a terminal node that represents a primitive task, and the associated action is executable in M, then as at 164, the current model is updated with the corresponding action and the next mandatory node N′ is sought for exploration. An assessment is made at 166 as to whether a new node N′ can be found. If so, then at 168, the model M′ is set in N′ to be the new updated model in N, and the current node N is set to N′. At this point, the process returns to 154. If not, i.e., a solution is found, then the solution is extracted and output as at 170, and a determination is made whether to continue the search at 172. If the search is continued, the process returns to 158. If the search is not continued, the process is terminated as at 174.

Returning to 158, if the next alternative node N′ is found as at 159, then as at 176, the search graph is updated by removing the node N″ which is a sibling of node N′ and an ancestor of node N and all descendants of node N″ (including node N) from the graph, and the current node N is set to N′. The process then returns to 154.

Returning to 160, if N is not deemed terminal, then at 180, the tasks T at N are matched with method instances/actions whose conditions are satisfied in model M. A new node is created for each unifiable method/action with the same model, the combination of constraint C and constraint defined in the method, if it exists. A determination is made if a new node is to be created as at 182, and if not, the process moves to 158 to find the next alternative node N′. If so, the process proceeds to 184, where the current node N is set to the new node based on the temporal constraint and the heuristic. The process then returns to 154.

In various embodiments, the HMTP temporal planner can be implemented on top of MTP in C++, and can include a parser for MPDDL and HTN knowledge, including methods, objective tasks, and temporal constraints between tasks. The HMTP can further include the AND/OR forward search in the continuous model space as described in connection with FIG. 3 above. As with MTP, the input problem can be provided in two text files, one that describes the domain of the problem and the other that specifies the problem instance. The input domain file can be similar to that for MTP with the addition of methods to specify domain specific HTN knowledge for the task decomposition for solutions. The input problem file can be a modification of that for MTP for the description of objective tasks and the temporal constraints between them.

It will be appreciated that the present disclosure not only contemplates temporal planning, but further contemplates temporal re-planning, including re-planning with the temporal planning component and with non-disruptive constraints. Re-planning addresses the problem of modifying a plan/schedule in various scenarios, such as (a) when a new objective task is added to the set of objective tasks to be performed, (b) when an existing objective task is cancelled, and (c) when some event occurs unpredictably and invalidates the current plan, for example. In re-planning, it is desirable to produce a new plan/schedule that not only works for the new problem, but also restricts disruption due to the changes. In various embodiments, the present disclosure specifies and/or defines the problem, including a non-disruptive constraint, problem input and output. Using the temporal logic (e.g., MPMTL) component and the temporal language (e.g., MPDDL) to represent the problem and the HMTP planner component to solve the problem, a loop algorithm can be provided for checking whether the input non-disruptive constraints are valid. If so, then the HMTP planner component can be used to solve the problem.

An exemplary re-planning problem with non-disruptive constraints can include (a) the current world model, i.e., a vector of timelines of the form:

<x=(b₁,c₁),I₁> . . . <x=(bₖ,cₖ),Iₖ>

For each variable x in the problem, where Iᵢ is time interval in the horizon [0, ∞), b is a real constants denoting the slope x is linearly changing in the interval Iᵢ and cᵢ is the value of x at the start point of Iᵢ. If bᵢ is zero then x is a constant and equal to cᵢ over the interval Iᵢ. By using the world model, the planner should know the exact value of a variable at any time point and can reason about planning with both discrete and continuous changes at any time points for any time intervals. The current world model should account for the changes by the event and the effects of actions already executed.

Such an exemplary re-planning problem with non-disruptive constraints can also include (b) the set of actions, with their start time and duration, in the current plan that have not been executed and are not cancelled, (c) the set of actions that must be performed as specified in the current plan, which can be considered the non-disruptive constraint for the re-planning problem, and (d) the set of objective tasks, possibly with temporal constraints among them. This set of objective tasks includes the objective tasks in the original problem that have not completed and are not cancelled in addition to any new objective tasks that exist.

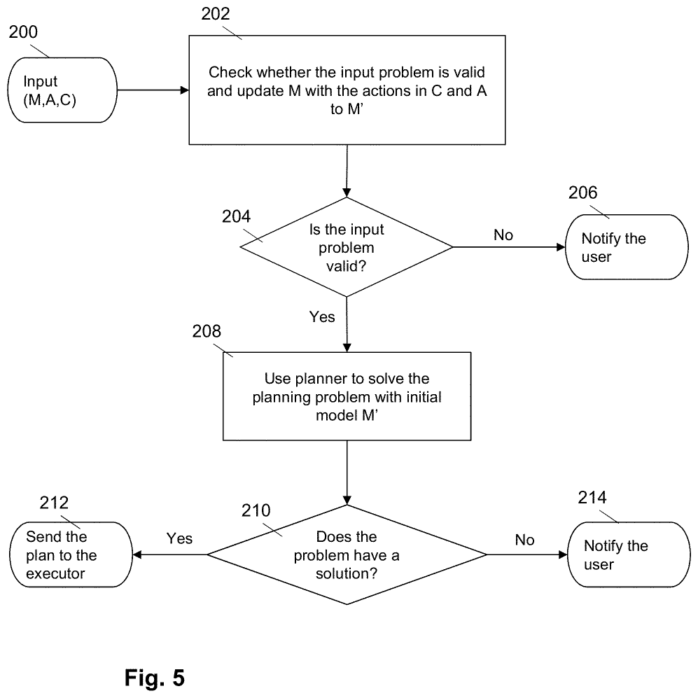

For a re-planning problem, the actions of the current plan that have already been performed (either successfully or not) do not need to be considered. Further, any world model prior to the current one does not need to be considered. In fact, the effects of these actions and any prior world model have been already captured in the current model. Thus, the current world model M and the rest of the current plan need only be considered, wherein the rest of the current plan is a set of actions A. If C is the non-disruptive constraint (recall that C is a subset of A that must be performed as specified in the current plan). The abstract algorithm for replanning is illustrated in FIG. 5, and consists of two main stages: (1) checking whether the input problem (M,A,C) is valid and updating the world model accordingly, and (2) solving the problem using the planner component, such as the HTMP planner component. As shown, for example, at 200 in FIG. 5, the input includes the model M, actions A and a non-disruptive constraint C. A check is made at 202 as to whether the input problem is valid, such as whether the non-disruptive constraint C is possible given M and A. M can also be updated with the actions in C and A to M′. If the input problem is invalid as determined at 204, then the user can be notified as at 206. If the input problem is valid, then the planner component can be used to solve the planning problem with initial model M′, as at 208. An assessment is then made at 210 to determine whether the problem has a solution, and if so, the solution plan is sent to the executor as at 212. If not, the user is notified as at 214.

As described earlier, the input for re-planning includes the set of actions of the current plan that have not been performed and this set contains the actions that must be performed in the new plan. Hence, the temporal language MPDDL can be extended for specifying the two sets of unperformed actions in the current plan. The first set is the non-disruption constraint that must be included in the new plan and performed later, and the second set consists of the unperformed actions.

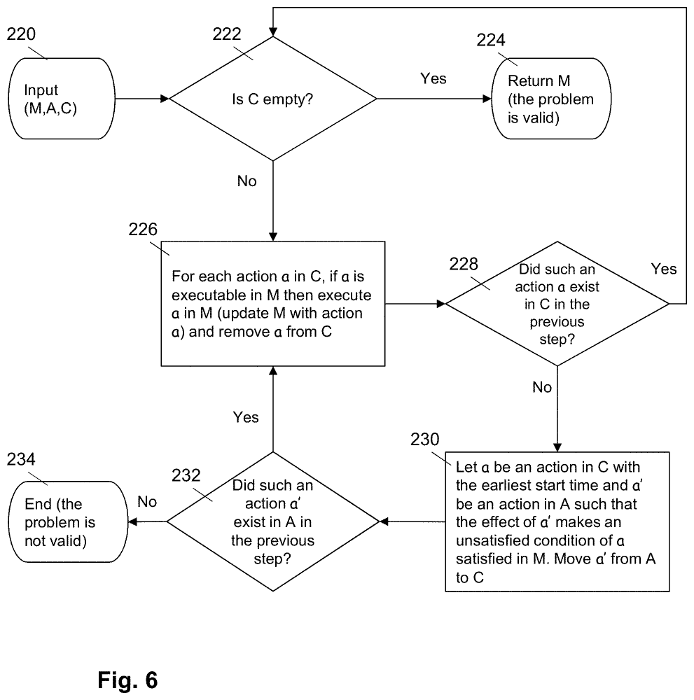

With regard to checking the validity of the input problem and updating the model M, FIG. 6 illustrates a sample process flow. As shown at 220 therein, input is provided, and at 222, a determination is made as to whether C is empty. If so, the problem is deemed valid at 224. If not, then at 226, for each action α in C, if α is executable in M then execute α in M (update M with action α) and remove α from C. Further, as at 228, a determination is made as to whether such an action α existed in C. If yes, the process returns to 222. If not, then as at 230, the algorithm assigns α to be an action in C with the earliest start time and α′ to be an action in A such that the effect of α′ makes an unsatisfied condition of α satisfied in M. α is then moved from A to C. Next, at 232, a determination is made as to whether an action α exists in A in the previous step, and if so, the process returns to 226. If not, the problem is deemed invalid as at 234.

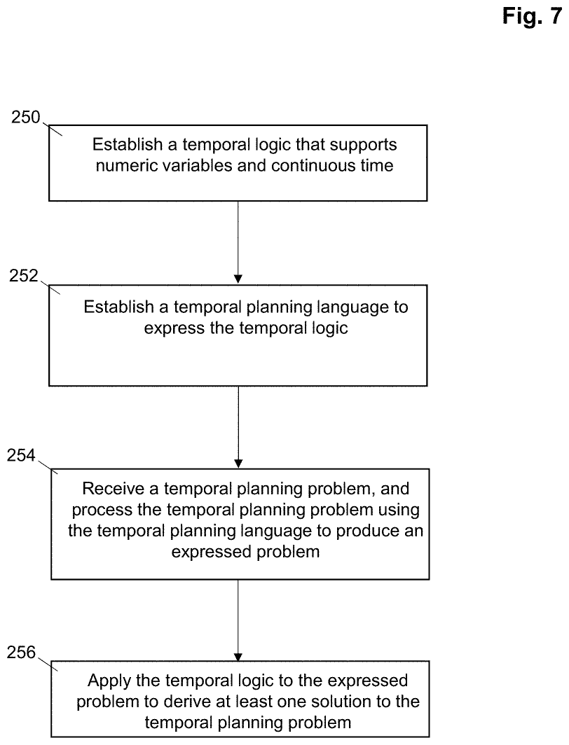

FIG. 7 shows a flow diagram illustrating a method in accordance with the present disclosure. As shown therein, at 250, a temporal logic is established that supports numeric variables and continuous time. In various embodiments, the established temporal logic represents a world model. As at 252, a temporal planning language is established to express the temporal logic. The temporal planning language can support formulas for expressing temporal constraints, conditions, models and goals of the world model. As at 254, a temporal planning problem is received, such as by host controller 40 of FIG. 1, and the temporal planning problem is processed using the temporal planning problem to produce an expressed problem. As at 256, the temporal logic is applied to the expressed problem to derive one or more solutions to the temporal planning problem. In various embodiments, such as described elsewhere herein, one or more search algorithms are created in continuous model space as part of deriving one or more solutions. The search algorithm(s) can be deployed against the expressed problem.

An example operation according to an embodiment of the present disclosure follows. In this example, there are two files as described above. The first file describes the domain of the problem and the second file describes a problem instance.

### EXAMPLE 1

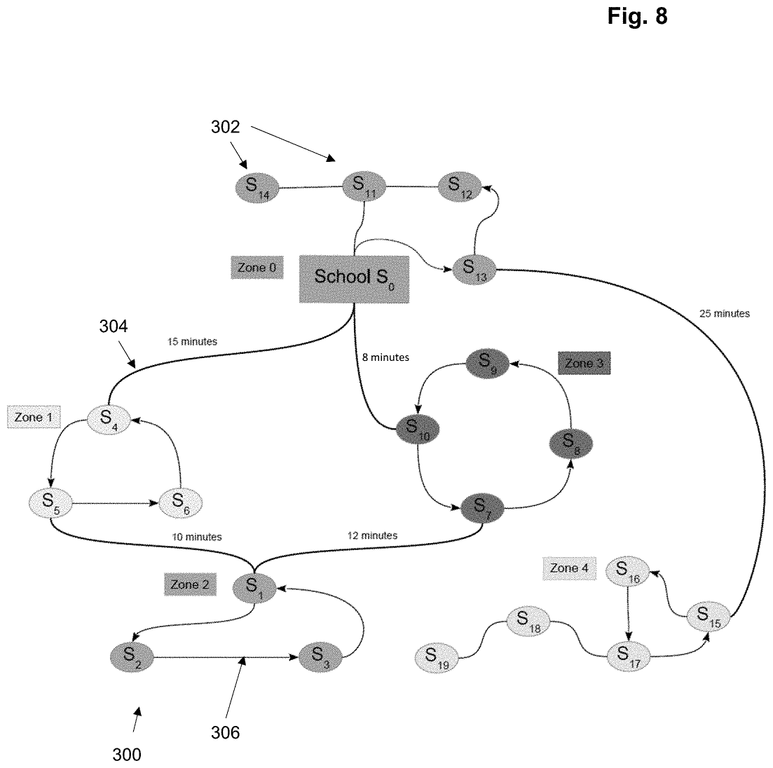

This example pertains to a school busing problem where there are an established number of buses, routes, school zones and pickup/drop off stations, and students need to be picked up and dropped off in a timely and efficient manner. The specific problem to be solved is to create a route, pickup and drop off schedule for a fleet of school buses for a school season. For example, as shown in FIG. 8, there are five zones (e.g., 300), ten buses (not shown) and twenty stations (e.g., 302). The line connection without arrows between two stations (e.g., 304) illustrates a two-way route that permits travel in both directions, whereas the line connection with a single arrow between two stations (e.g., 306) illustrates a one-way route only permitting travel in the direction of the arrow shown. It will be assumed that all of the connections between stations are five minutes in travel time unless otherwise specified in FIG. 8.

The problem definition file defines the objects according to the number of zones, buses and stations in the domain. For example, with five zones, there is a zone0, zone1, zone2, zone3 and zone4. Initially, all of the buses are at school. Timelines are established which specify a time range allowed for picking up students at each station. For example, picking up at station S01 is permitted from 6:30 am to 8 am. Some pickup time ranges may be later based on location and other factors, and this is specified in the problem definition file. The unloading time should be between 7 am and 8:15 am, with the assumption that the school starts at 8:30 am. One-way and two-way direct connections are specified, along with the zone that each station belongs to, the capacity for each bus, the notion that all buses are initially empty and ready to load up to its capacity, and the number of students that need to be picked up at each station. The minimum driving distance between stations is also specified, along with the average pickup time, average time to unload a bus and maximum number of buses that can be unloading at the same time. Tasks are also defined, such as transporting riders from specific zones to the school.

Temporal constraints are also defined regarding the performing time for the tasks. In the examples in the file below, “?ts_i” is used to denote the start time for task i-th, i.e., ts_0 is the start time for the first task (TransportZoneToSchoolM zone2), “?te_i” indicates the end time for task i-th and “?duration” indicates the time span performing all the tasks, i.e., the latest end time of a task minus the earliest start time of a task. In this way, the present disclosure can describe much more complicated temporal constraints than previous systems. Other rules or constraints can include, for example, that a task must start or end before or after another task starts or ends for a certain number of time units, and/or the duration of a task is greater, equal to, or smaller than a specific number. This is superior to only directing whether a task must perform after another completes or there is no order constraint between them, and a task must end by a specified time.

An illustrative problem definition file “File 1” for the above problem follows.

An illustrative knowledge file is shown as File 2 below and uses various rules and strategies for solving the problem.

As illustrated in File 2 below, there are predicates such as a bus is at a station, a bus is busy (e.g., picking up or unloading riders), a time range is defined, a one-way travel connection is defined, and so forth. Functions are also defined, such as bus capacity, number of currently available seats on a bus, and so forth. Object fluents are also defined, such as ‘(zone_of_station ?s—Station)—Zone’ in file 2, for example, to specify the zone the station ?s belongs to. The effect of an action is also specified in terms of how it changes the world state. Actions to “Pickup” and “Unload” are also illustrated below, including associated parameters, duration, condition and effect.

File 2

(define (domain School_Bus)

(:requirements :negative-preconditions :typing :equality)
(:types Bus Station Zone)
(:constants school − Station
)
(:predicates

(at_station ?b − Bus ?s − Station); the bus ?b is at station ?s
(busy ?b − Bus);the bus is going out to pickup students or

unloading at school

(pickup_time ?s − Station); time range allowed for picking up at

station ?s

(unload_time); time range allowed for a bus to unload at school
(direct ?s1 ?s2 − Station); one-way direct connection from station

?s1 to ?s2

(station_zone ?s − Station ?z − Zone); station ?s belongs to zone ?z

)
(:functions

(capacity ?b − Bus); capacity of the bus ?b (maximum number of

students it can carry at the same time)

(seat_availability ?b − Bus); number of available seats on the bus at

the moment

(no_of_students_at_station ?s − Station); number of students need

to be picked up at the station ?s

(unloading_buses) ;number of buses that are unloading at the time

at the school station

(max_unloading_buses) ; maximum number of buses allowed to

unload at the same time at school

(driving_time ?s1 ?s2 − Station) ; minimum driving time from ?s1

to ?s2 (using the shortest way)

(loading_time); average elapsed time needed for loading students

each time

(unloading_time); average elapsed time needed for unloading

students at school each time

(min_operation_time ?s − Station) = (loading_time) +

(driving_time ?s school) + (unloading_time)

;the minimum amount of time for the bus to go to station ?s, load

students there, return to school, and unload

;this is used to check whether the bus still have time to pick up

students at a station, return school and unload

;during the permitted time range
(d_unit); distance-unit, the minimum distance between stations

)
(:object_fluents

(zone_of_station ?s − Station) − Zone; this function returns the

(name of the) zone for a station

)

; Action drive for the bus to drive from a station (?from) to another station (?to)
(:action Drive

:parameters (?b − Bus ?from ?to − Station); the parameters for the action: the bus, the

station where it is at the time, and the destination (?to)

;The duration of the drive action is the time distance from the current station to the

destination

:duration (?duration = (driving_time ?from ?to)
)
;The condition for executing the action: the bus must be at the specified station (?from) at

the time

| | |
|---|---|
| :condition ( | (at_station ?b ?from) |

)
;The effect of action specifies how the action changes the world
;<−(at_station ?b ?from), [?ts, inf)>: the bus is not at the station from the time ?ts it starts

driving

;<(at_station ?b ?to), [?ts+?duration, inf)>: the bus will be at the destination station from

the time it arrives (?ts+?duration)

| ;<(busy ?b), [?ts, inf)>: the bus is busy since it starts driving | |
|---|---|
| :effect (and | <−(at_station ?b ?from), [?ts, inf)> |

<(at_station ?b ?to), [?ts+?duration, inf)>
<(busy ?b), [?ts, inf)>

)

)
(:action Pickup

:parameters (?b − Bus ?s − Station); the Pickup action has two parameters bus ?b and

station ?s, meaning the bus ?b is picking up students at station ?s
;Output is optional. If it is not specified then the output is the list of parameter values in that
order.

:output (

Bus: ?b
Station: ?s
Zone: (zone_of_station ?s)
loaded_qty: (loaded_qty)
seat_availability: (remaining_seats)
remaining_waiting_students: (remaining_students_at_station)

)

;Local functions, whose value is evaluated by the expression at the start time (?ts) of the action

:functions (

(loaded_qty) = min((no_of_students_at_station ?s), (seat_availability ?b))
(remaining_seats) = (seat_availability ?b) − (loaded_qty)
(remaining_students_at_station) = (no_of_students_at_station ?s) − (loaded_qty)

)

;The duration of this action is the average loading time

:duration (?duration = (loading_time)
)

;The condition for the Pickup action includes:
;The bus ?b is at station ?s at the time, specified by the predicate (at_station ?b ?s)
;The number of students waiting for picking up at station ?s is greater than zero, denoted by:
(no_of_students_at_station ?s) > 0
;The number of available seats on bus ?b is greater than zero ((seat_availability ?b) > 0)
;It must start during the allowed time range for picking up at station ?s (<(pickup_time ?s), [?ts,
?ts]>)

| | |
|---|---|
| :condition ( | (at_station ?b ?s) & |

(no_of_students_at_station ?s) > 0 &
(seat_availability ?b) > 0 &
<(pickup_time ?s), [?ts, ?ts]>

)

;The effect of Pickup is that the number of available seats on bus ?b is reduced by the number of
students loaded this time. This number is either the number of students that need to be picked up
or the number of available seats on ?b, whichever is smaller.
;After picking up, the number of students to be picked reduced by the same number.

| | |
|---|---|
| :effect (and | <(seat_availability ?b) −= min((no_of_students_at_station ?s), |

(seat_availability ?b)), [?ts, inf)>

<(no_of_students_at_station ?s) −= min((no_of_students_at_station ?s),

(seat_availability ?b)), [0, inf)>

)

)
(:action Unload

:parameters (?b − Bus)

:output (

?b
qty: (capacity ?b)−(seat_availability ?b)

)
:duration (?duration = (unloading_time)
)
;The condition for unloading bus ?b includes:
; The bus ?b is at school at the time
; The bus is not empty, denoted by (seat_availability ?b) < (capacity ?b)
; It must be done during the allowed time range
; The number of busses that are unloading at the time does not exceed the maximum

number of busses that can unload at the same time

| | |
|---|---|
| :condition ( | (at_station ?b school) & |

(seat_availability ?b) < (capacity ?b) &
<(unload_time), [?ts, ?ts+?duration)> &
(unloading_busses) < (max_unloading_buses)

)

;This action results in:

;The number of available seats in increased to the capacity of the bus (first line in the

condition section)

;The number of unloading busses is increased by 1 during this action (second and third

lines)

| ;The bus ?b is not busy since finishes unloading and free for another pass (last line) | |
|---|---|
| :effect (and | <(seat_availability ?b) += (capacity ?b)−(seat_availability ?b), |

[?ts+?duration, inf)>

<(unloading_busses) += 1, [?ts, inf)>
<(unloading_busses) −= 1, [?ts+?duration,inf)>
<−(busy ?b), [?ts+?duration, inf)>

)

)

In terms of using and developing methods for directing the temporal planner how to perform certain actions, scheme conditions can be described as strictly as possible to avoid any redundant decomposition searching. For example, for the method “DriveM” below, the condition for the first scheme is defined such that the bus can go directly to only stations which are directly connected from the station where the bus currently is. An exemplary method is shown below for directing the HMTP temporal planner how to send out a bus to a specified zone ?z where there are still students who need a ride to school.

(:method TransportZoneToSchoolM

:parameters (?z − Zone)
:one_unifiable ; This keyword specifies that only the first unifiable (feasible) scheme is

applied in the search (decomposition)

; In this particular method, if there is a station where there are students to be

picked up and there is an available bus then the planner will continue to arrange for the bus to go
out pick up the students at the station. Otherwise (the condition is not met), it will apply the
second scheme, i.e., nothing further to be done.

%Scheme 1:
:scheme_parameters (?s − Station ?b − Bus)
; The condition for this scheme is there is a station ?s where some students still need to be

picked up and there is an available bus ?b

:condition ((station_zone ?s ?z) &

<(no_of_students_at_station ?s) > 0, [?ts, inf)> &
<−(busy ?b), [?ts, inf)>

)
; This is a recursive method, i.e., if the above condition is met then the bus is sent out to

the station for transportation (by the method

; (TransportStationToSchoolM ?z ?s ?b)) and it repeats for other buses and stations until

no more available buses or no more work to be done.

:subtasks ( (TransportStationToSchoolM ?z ?s ?b)

(TransportZoneToSchoolM ?z)

)
%Scheme 2: No more work to be done
:subtasks ( )

)

The following method makes a plan for an available bus ?b at school to go to station ?s at zone ?z to pickup students at ?b and maybe at other station(s) later depending on the circumstance later.

(:method TransportStationToSchoolM

:parameters (?z − Zone ?s − Station ?b − Bus)
:one_alternative ;This keyword specifies that only the first feasible instantiation of a

scheme is applied and all the rest will be discarded. This differs from the keyword one_unifiable
that if one_unifiable is set, then all the instantiations of the first successfully unified

;schemes may be applied (alternatively) in the search.
%Scheme 1:
; The first condition specifies that the earliest time for the bus to go pick up students at

station ?s, return, and unload is still not too late with respect to the regulated time range for
unloading

; The second condition makes sure the bus arrives at the station not too late w.r.t. the

regulated time range for picking up at that station

:condition (<(unload_time), [?ts+(driving_time school ?s)+(min_operation_time ?s),

?ts+(driving_time school ?s)+(min_operation_time ?s)]> &

<(pickup_time ?s), [?ts+(driving_time school ?s), ?ts+(driving_time school

?s)]>

)

; There are three sub tasks (actions or methods) in this method:

% 1) Method (DriveM ?b school ?s): the bus ?b going to the station ?s from school
% 2) Action (Pickup ?b ?s): Picking up students at station ?s to the bus ?b
% 3) Method (PickupAndReturnM ?b ?z ?s): picking up more at other stations, if it is

needed and possible, returning to school, and unloading students

:subtasks ( (DriveM ?b school ?s)

(Pickup ?b ?s)
(PickupAndRetumM ?b ?z ?s)

)
:sequential ;This keyword specifies that the tasks are performed sequentially, one right

after another
)
(:method DriveM

:dummy ; A dummy method or action is generally used only for computation and is

generally not shown in the output plans. However, non-dummy actions that are descendants of
dummy methods can also be shown in the output plans.

:parameters (?b − Bus ?from ?to − Station)
:one_unifiable
;(direct ?from ?to) means the destination ?to is directly connected from the station ?from

where the bus is at. In this case,

;the action (Drive ?b ?from ?to) can be applied directly and no more complicated routes

(scheme 2) is needed to be considered

%Scheme 1
:condition ( (direct ?from ?to)
)
:subtasks ( (Drive ?b ?from ?to)
)

; If the current station (?from) is not directly connected to the destination station ?to, then a
possible route should be indirect through a station (?next) that is directly connected from the
current station (first condition). However, the second condition is used to avoid inefficient
routes, which is longer than the minimum route by (d_unit), the minimum driving distance
between two stations.

%Scheme 2
:scheme_parameters (?next − Station)
:condition ( (direct ?from ?next) &

(driving_time ?from ?to) >= (driving_time ?from ?next) + (driving_time ?next

?to) − (d_unit)

)

; This method is applied recursively. First go to the next station and apply the method DriveM
again to find the route from this neighbor station to the destination

:subtasks ( (Drive ?b ?from ?next)

(DriveM ?b ?next ?to)

)
In the below exemplary temporal constraints, among the performing time for the tasks,

the following are used:

?ts_i to denote the start time for task i-th, i.e., ts_0 is the start time for the first task

(TransportZoneToSchoolM zone2)

?te_i to indicate the end time for task i-th
?duration for the time span performing all the tasks, i.e., the latest end time of a task

minus the earliest start time of a task

Examples in this problem are given below. Also, for example, a task can be specified such that it must start or end before or after another task starts or ends for a certain number of time units. This is superior to simply specifying whether a task must perform after another completes or if there is no order constraint between them at all. This is because a state-based approach does not track the value of a variable over continuous time and will not be able to know the value of variables at a time point when multiple tasks are performing in parallel that affect the variable. Hence, the state-based approach only can plan where each task can perform only when all other tasks are completed or they do not affect or be affected by the same variable.

In this example problem, many variables are shared among different tasks, e.g., number of students to be picked up at a bus station and number of buses that are unloading at the school. Thus, the presently disclosed system and method are uniquely able to describe this problem.

:order(

?ts_1 = ?te_0

)

)
(:method PickupAndReturnM

:dummy
:parameters (?b − Bus ?z − Zone ?s − Station)
:one_unifiable ; chose only the first unifiable (feasible) scheme. This means the earlier

the more preferable scheme.

%Scheme 1: Go to pickup at the nearest station (first condition) at the same zone (second

condition) first if there are students to be picked up (third condition), there is available room on
the bus (fourth condition), and the time permits for picking up (fifth condition) and for unloading
(last condition)

| :scheme_parameters (?s1 − Station) | |
|---|---|
| condition ( | (direct ?s ?s1) & |

(station_zone ?s1 ?z) &
<(no_of_students_at_station ?s1) > 0, [?ts, inf)> &
<(seat_availability ?b) > 0, [?ts, inf)> &
<(pickup_time ?s1), [?ts+(driving_time ?s ?s1), ?ts+(driving_time ?s

?s1)]> &

<(unload_time), [?ts+(driving_time ?s ?s1)+(min_operation_time ?s1),

?ts+(driving_time ?s ?s1)+(min_operation_time ?s1)]>

)

;Drive the bus to the next station ?s1, pick up the students there, and recursively apply this
method for picking up and returning at the new station ?s1

:subtasks ( (Drive ?b ?s ?s1)

(Pickup ?b ?s1)
(PickupAndReturnM ?b ?z ?s1)

)
:sequential
%Scheme 2: Go to pickup at a station at the SAME zone ?z. This case does not requires

the station to be directly connected from the current station. However, other conditions should
be the same as for the previous case (scheme)

| :scheme_parameters (?s1 − Station) | |
|---|---|
| :condition ( | (station_zone ?s1 ?z) & |

<(no_of_students_at_station ?s1) > 0, [?ts, inf)> &
<(seat_availability ?b) > 0, [20, inf)> &
<(unload_time), [?tsp+(driving_time ?s ?s1)+(min_operation_time ?s1),

?ts+(driving_time ?s ?s1)+(min_operation_time ?s1)]> &

<(pickup_time?s1), [?ts+(driving_time ?s ?s1), ?ts+(driving_time ?s

?s1)]>

)
:subtasks ( (DriveM ?b ?s ?s1)

(Pickup ?b ?s1)
(PickupAndRetumM ?b ?z ?s1)

)
:sequential
%Scheme 3: Go to pickup at a station ?s1 that is directly connected to the current station

but at another zone ?z1. Other conditions should be the same as for the Scheme 1

| :scheme_parameters (?z1 − Zone ?s1 − Station) | |
|---|---|
| :condition ( | (direct ?s ?s1) & |

(station_zone ?s1 ?z1) &
<(no_of_students_at_station ?s1) > 0, [?ts, inf)> &
<(seat_availability ?b) > 0, [20, inf)> &
<(unload_time), [?ts+(driving_time ?s ?s1)+(min_operation_time ?s1),

?ts+(driving_time ?s ?s1)+(min_operation_time ?s1)]> &

<(pickup_time?s1), [?ts+(driving_time ?s ?s1), ?ts+(driving_time ?s

?s1)]>

)
:subtasks ( (Drive ?b ?s ?s1)

(Pickup ?b ?s1)
(PickupAndRetumM ?b ?z1 ?s1)

)
:sequential
%Scheme 4: Go to pickup at a station, that is not required directly connected from the

current station, at another zone. Other conditions are the same as for the Scheme 3

| :scheme_parameters (?z1 − Zone ?s1 − Station) | |
|---|---|
| :condition ( | (station_zone ?s1 ?z1) & |

<(no_of_students_at_station ?s1) > 0, [?ts, inf)> &
<(seat_availability ?b) > 0, [20, inf)> &
<(unload_time), [?ts+(driving_time ?s ?s1)+(min_operation_time ?s1),

?ts+(driving_time ?s ?s1)+(min_operation_time ?s1)]> &

<(pickup_time ?s1), [?ts+(driving_time ?s ?s1), ?ts+(driving_time ?s

?s1)]>

)
:subtasks ( (DriveM ?b ?s ?s1)

(Pickup ?b ?s1)
(PickupAndRetumM ?b ?z1 ?s1)

)
:sequential
%Scheme 5: No more picking up as needed or possible, just return school and unload
:subtasks ( (DriveM ?b ?s school)

(Unload ?b)

)
:consecutive ;This keyword specifies that action Unload can be performed when the

driving is completed and the bus is already at the school.
))

Upon employing a solution approach as described elsewhere herein, an exemplary output plan is shown below.

(TransportZoneToSchoolM zone2) 6:00-8:14
(TransportStationToSchoolM zone2 s01 b0) 6:00-7:48
   1: (Drive b0 school s10) 6:15-6:23
   2: (Drive b0 s10 s07) 6:23-6:28
   3: (Drive b0 s07 s01) 6:28-6:40
   4: (Pickup Bus: b0 Station: s01 Zone: zone2 loaded_qty: 10 seat_availability: 15 remaining_waiting_students: 0) 6:40-6:43
   5: (Drive b0 s01 s02) 6:43-6:48
   6: (Pickup Bus: b0 Station: s02 Zone: zone2 loaded_qty: 15 seat availability: 0 remaining_waiting_students: 0) 6:48-6:51
   7: (Drive b0 s02 s03) 6:51-6:56
   8: (Drive b0 s03 s01) 6:56-7:01
   9: (Drive b0 s01 s05) 7:01-7:11
   10: (Drive b0 s05 s06) 7:11-7:16
   11: (Drive b0 s06 s04) 7:16-7:21
   12: (Drive b0 s04 school) 7:21-7:36
   13: (Unload b0 qty: 25) 7:36-7:48
(TransportStationToSchoolM zone2 s03 b1) 6:00-7:33
   14: (Drive b1 school s10) 6:00-6:08
   15: (Drive b1 s10 s07) 6:08-6:13
   16: (Drive b1 s07 s01) 6:13-6:25
   17: (Drive b1 s01 s02) 6:25-6:30
   18: (Drive b1 s02 s03) 6:30-6:35
   19: (Pickup Bus: b1 Station: s03 Zone: zone2 loaded_qty: 10 seat_availability: 15 remaining_waiting_students: 0) 6:35-6:38
   20: (Drive b1 s03 s01) 6:38-6:43
   21: (Drive b1 s01 s05) 6:43-6:53
   22: (Drive b1 s05 s06) 6:53-6:58
   23: (Drive b1 s06 s04) 6:58-7:03
   24: (Pickup Bus: b1 Station: s04 Zone: zone1 loaded_qty: 15 seat_availability: 0 remaining_waiting_students: 0) 7:03-7:06
   25: (Drive b1 s04 school) 7:06-7:21
   26: (Unload b1 qty: 25) 7:21-7:33

(TransportZoneToSchoolM zone4) 6:00-8:14
(TransportStationToSchoolM zone4 s17 b5) 6:00-8:06
   27: (Drive b5 school s13) 6:00-6:05
   28: (Drive b5 s13 s15) 6:05-6:30
   29: (Drive b5 s15 s16) 6:30-6:35
   30: (Drive b5 s16 s17) 6:35-6:40
   31: (Pickup Bus: b5 Station: s17 Zone: zone4 loaded_qty: 10 seat_availability: 10 remaining_waiting_students: 0) 6:40-6:43
   32: (Drive b5 s17 s15) 6:43-6:48
   33: (Pickup Bus: b5 Station: s15 Zone: zone4 loaded_qty: 10 seat_availability: 0 remaining_waiting_students: 0) 6:48-6:51
   34: (Drive b5 s15 s13) 6:51-7:16
   35: (Drive b5 s13 s12) 7:16-7:21
   36: (Drive b5 s12 s11) 7:21-7:26
   37: (Drive b5 s11 school) 7:26-7:31
   38: (Unload b5 qty: 20) 7:31-7:43
(TransportStationToSchoolM zone4 s16 b2) 6:00-8:06
   39: (Drive b2 school s13) 6:00-6:05
   40: (Drive b2 s13 s15) 6:05-6:30
   41: (Drive b2 s15 s16) 6:30-6:35
   42: (Pickup Bus: b2 Station: s16 Zone: zone4 loaded_qty: 15 seat_availability: 10 remaining_waiting_students: 0) 6:35-6:38
   43: (Drive b2 s16 s17) 6:38-6:43
   44: (Drive b2 s17 s18) 6:43-6:48
   45: (Pickup Bus: b2 Station: s18 Zone: zone4 loaded_qty: 10 seat_availability: 0 remaining_waiting_students: 5) 6:48-6:51
   46: (Drive b2 s18 s17) 6:51-6:56
   47: (Drive b2 s17 s15) 6:56-7:01
   48: (Drive b2 s15 s13) 7:01-7:26
   49: (Drive b2 s13 s12) 7:26-7:31
   50: (Drive b2 s12 s11) 7:31-7:36
   51: (Drive b2 s11 school) 7:36-7:41
   52: (Unload b2 qty: 25) 7:41-7:53
(TransportStationToSchoolM zone4 s18 b3) 6:00-8:06
   53: (Drive b3 school s13) 6:00-6:05
   54: (Drive b3 s13 s15) 6:05-6:30
   55: (Drive b3 s15 s16) 6:30-6:35
   56: (Drive b3 s16 s17) 6:35-6:40
   57: (Drive b3 s17 s18) 6:40-6:45
   58: (Pickup Bus: b3 Station: s18 Zone: zone4 loaded_qty: 5 seat_availability: 20 remaining_waiting_students: 0) 6:45-6:48
   59: (Drive b3 s18 s19) 6:48-6:53
   60: (Pickup Bus: b3 Station: s19 Zone: zone4 loaded_qty: 10 seat_availability: 10 remaining_waiting_students: 0) 6:53-6:56
   61: (Drive b3 s19 s18) 6:56-7:01
   62: (Drive b3 s18 s17) 7:01-7:06
   63: (Drive b3 s17 s15) 7:06-7:11
   64: (Drive b3 s15 s13) 7:11-7:36
   65: (Drive b3 s13 s12) 7:36-7:41
   66: (Drive b3 s12 s11) 7:41-7:46
   67: (Pickup Bus: b3 Station: s11 Zone: zone0 loaded_qty: 10 seat_availability: 0 remaining_waiting_students: 0) 7:46-7:49
   68: (Drive b3 s11 school) 7:49-7:54
   69: (Unload b3 qty: 25) 7:54-8:06

(TransportZoneToSchoolM zone1) 6:00-8:14
(TransportStationToSchoolM zone1 s05 b4) 6:12-7:15
   70: (Drive b4 school s04) 6:12-6:27
   71: (Drive b4 s04 s05) 6:27-6:32
   72: (Pickup Bus: b4 Station: s05 Zone: zone1 loaded_qty: 10 seat_availability: 15 remaining_waiting_students: 0) 6:32-6:35
   73: (Drive b4 s05 s06) 6:35-6:40
   74: (Pickup Bus: b4 Station: s06 Zone: zone1 loaded_qty: 15 seat_availability: 0 remaining_waiting_students: 0) 6:40-6:43
   75: (Drive b4 s06 s04) 6:43-6:48
   76: (Drive b4 s04 school) 6:48-7:03
   77: (Unload b4 qty: 25) 7:03-7:15

(TransportZoneToSchoolM zone3) 6:00-8:14
(TransportStationToSchoolM zone3 s10 b9) 6:12-7:36
   78: (Drive b9 school s10) 6:42-6:50
   79: (Pickup Bus: b9 Station: s10 Zone: zone3 loaded_qty: 15 seat_availability: 5 remaining_waiting_students: 0) 6:50-6:53
   80: (Drive b9 s10 s07) 6:53-6:58
   81: (Pickup Bus: b9 Station: s07 Zone: zone3 loaded_qty: 5 seat_availability: 0 remaining_waiting_students: 5) 6:58-7:01
   82: (Drive b9 s07 s08) 7:01-7:06
   83: (Drive b9 s08 s09) 7:06-7:11
   84: (Drive b9 s09 s10) 7:11-7:16
   85: (Drive b9 s10 school) 7:16-7:24
   86: (Unload b9 qty: 20) 7:24-7:36
(TransportStationToSchoolM zone3 s07 b6) 6:12-7:26
   87: (Drive b6 school s10) 6:27-6:35
   88: (Drive b6 s10 s07) 6:35-6:40
   89: (Pickup Bus: b6 Station: s07 Zone: zone3 loaded_qty: 5 seat_availability: 15 remaining_waiting_students: 0) 6:40-6:43
   90: (Drive b6 s07 s08) 6:43-6:48
   91: (Pickup Bus: b6 Station: s08 Zone: zone3 loaded_qty: 15 seat_availability: 0 remaining_waiting_students: 0) 6:48-6:51
   92: (Drive b6 s08 s09) 6:51-6:56
   93: (Drive b6 s09 s10) 6:56-7:01
   94: (Drive b6 s10 school) 7:01-7:09
   95: (Unload b6 qty: 20) 7:09-7:21
(TransportStationToSchoolM zone3 s09 b7) 6:12-7:26
   96: (Drive b7 school s10) 6:12-6:20
   97: (Drive b7 s10 s07) 6:20-6:25
   98: (Drive b7 s07 s08) 6:25-6:30
   99: (Drive b7 s08 s09) 6:30-6:35
   100: (Pickup Bus: b7 Station: s09 Zone: zone3 loaded_qty: 10 seat_availability: 10 remaining_waiting_students: 0) 6:35-6:38
   101: (Drive b7 s09 s10) 6:38-6:43
   102: (Drive b7 s10 school) 6:43-6:51
   103: (Drive b7 school s11) 6:51-6:56
   104: (Drive b7 s11 s12) 6:56-7:01
   105: (Pickup Bus: b7 Station: s12 Zone: zone0 loaded_qty: 10 seat_availability: 0 remaining_waiting_students: 5) 7:01-7:04
   106: (Drive b7 s12 s11) 7:04-7:09
   107: (Drive b7 s11 school) 7:09-7:14
   108: (Unload b7 qty: 20) 7:14-7:26

(TransportZoneToSchoolM zone0) 6:00-8:14
(TransportStationToSchoolM zone0 s12 b8) 7:03-8:14
   109: (Drive b8 school s11) 7:03-7:08
   110: (Drive b8 s11 s12) 7:08-7:13
   111: (Pickup Bus: b8 Station: s12 Zone: zone0 loaded_qty: 5 seat_availability: 15 remaining_waiting_students: 0) 7:13-7:16
   112: (Drive b8 s12 s11) 7:16-7:21
   113: (Drive b8 s11 school) 7:21-7:26
   114: (Drive b8 school s13) 7:26-7:31
   115: (Pickup Bus: b8 Station: s13 Zone: zone0 loaded_qty: 10 seat_availability: 5 remaining_waiting_students: 0) 7:31-7:34
   116: (Drive b8 s13 s12) 7:34-7:39
   117: (Drive b8 s12 s11) 7:39-7:44
   118: (Drive b8 s11 s14) 7:44-7:49
   119: (Pickup Bus: b8 Station: s14 Zone: zone0 loaded_qty: 5 seat_availability: 0 remaining_waiting_students: 10) 7:49-7:52
   120: (Drive b8 s14 s11) 7:52-7:57
   121: (Drive b8 s11 school) 7:57-8:02
   122: (Unload b8 qty: 20) 8:02-8:14
(TransportStationToSchoolM zone0 s14 b4) 7:18-7:53
   123: (Drive b4 school s11) 7:18-7:23
   124: (Drive b4 s11 s14) 7:23-7:28
   125: (Pickup Bus: b4 Station: s14 Zone: zone0 loaded_qty: 10 seat_availability: 15 remaining_waiting_students: 0) 7:28-7:31
   126: (Drive b4 s14 s11) 7:31-7:36
   127: (Drive b4 s11 school) 7:36-7:41
   128: (Unload b4 qty: 10) 7:41-7:53

As can be seen, the output plan produces a schedule for each of the buses, including time for driving, time for pickup and time for unloading. These times are expressed as ranges in this embodiment.

In carrying out the above, it will be appreciated that the host controller of the present disclosure can comprise a computer-based system, where the components can be implemented in hardware, software, firmware, or combinations thereof.

Users of embodiments of the present disclosure can access the system and employ the method of the present disclosure and its user interfaces using client computing devices, such as desktop computers, laptop computers and mobile communications devices (MCDs), for example. It will be appreciated that the system of the present disclosure can incorporate necessary processing power and memory for storing data and programming that can be employed by the processor(s) to carry out the functions and communications necessary to facilitate the processes and functionalities described herein.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another do not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, at least one processor (e.g., a microprocessor or controller device) receives instructions from a memory or like storage device that contains and/or stores the instructions, and the at least one processor executes those instructions, thereby performing a process defined by those instructions. Further, programs that implement such methods and algorithms can be stored and transmitted using a variety of known media.

Common forms of computer-readable media that may be used in the performance of the present disclosure include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO.

Where databases are described in the present disclosure, it will be appreciated that alternative database structures to those described, as well as other memory structures besides databases may be readily employed. The descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

It will be apparent to one skilled in the art that any computer system that includes suitable programming means for operating in accordance with the disclosed methods also falls well within the scope of the present disclosure, including such systems as may be offered in a cloud computing environment. Suitable programming means include any means for directing a computer system to execute the steps of the system and method of the disclosure, including for example, systems comprised of processing units and arithmetic-logic circuits coupled to computer memory, which systems have the capability of storing in computer memory, which computer memory includes electronic circuits configured to store data and program instructions, with programmed steps of the method of the disclosure for execution by a processing unit. Aspects of the present disclosure may be embodied in a computer program product, such as a diskette or other recording medium, for use with any suitable data processing system. The present disclosure can further run on a variety of platforms, including Microsoft Windows™, Linux™, Sun Solaris™, HP/UX™, IBM AIX™ and Java compliant platforms, for example. Appropriate hardware, software and programming for carrying out computer instructions between the different elements and components of the present disclosure are provided.

The present disclosure describes numerous embodiments of the present disclosure, and these embodiments are presented for illustrative purposes only. These embodiments are described in sufficient detail to enable those skilled in the art to practice the disclosure embodiments, and it will be appreciated that other embodiments may be employed and that structural, logical, software, electrical and other changes may be made without departing from the scope or spirit of the present disclosure. Accordingly, those skilled in the art will recognize that the present disclosure may be practiced with various modifications and alterations. Although particular features of the present disclosure can be described with reference to one or more particular embodiments or figures that form a part of the present disclosure, and in which are shown, by way of illustration, specific embodiments of the disclosure, it will be appreciated that such features are not limited to usage in the one or more particular embodiments or figures with reference to which they are described. The present disclosure is thus neither a literal description of all embodiments of the disclosure nor a listing of features of the disclosure that must be present in all embodiments.

1. A method for temporal planning, comprising:
establishing a temporal logic for representing and reasoning about temporal constraints over discrete variables, continuous variables and continuous time;
establishing a temporal planning language for expressing the temporal logic;
receiving a temporal planning problem and processing the received temporal planning problem using the temporal planning language to produce an expressed problem; and
applying the temporal logic to the expressed problem to derive at least one solution to the temporal planning problem.

2. The method of claim 1, further comprising representing a planning problem world via the temporal logic continuously with a plurality of updates for the discrete and continuous variables.

3. The method of claim 1, further comprising representing temporal constraints, conditions, effects, and goals in the temporal planning problem via the temporal logic.

4. The method of claim 1, wherein the temporal planning language is established with a plurality of formulas for expressing the received temporal planning problem into the expressed problem.

5. The method of claim 1, wherein deriving at least one solution comprises establishing at least one search algorithm in continuous model space.

6. The method of claim 5, wherein deriving at least one solution further comprises deploying the at least one search algorithm against the expressed problem.

7. The method of claim 6, wherein the at least one search algorithm establishes a priority queue for a plurality of search nodes that are unexplored.

8. The method of claim 6, wherein deriving at least one solution further comprises decomposing at least one task.

9. The method of claim 1, wherein deriving at least one solution comprises reading and parsing the received temporal planning problem to determine and validate a format of the temporal planning problem.

10. The method of claim 9, wherein receiving the temporal planning problem comprises receiving at least one constraint, set of actions and set of tasks or goals associated with the temporal planning problem, and wherein deriving at least one solution comprises determining whether the received temporal planning problem is internally consistent.

11. A temporal planning system, comprising:
at least one processor; and
at least one memory device storing a plurality of instructions which, when executed by the at least one processor, cause the at least one processor to:
receive a temporal planning problem;
process the temporal planning problem using a temporal planning language to produce an expressed problem, wherein the temporal planning language expresses a temporal logic representing temporal constraints over discrete variables, continuous variables and continuous time; and
apply the temporal logic to the expressed problem to derive at least one solution to the temporal planning problem.

12. The temporal planning system of claim 11, wherein the received temporal planning problem comprises a problem domain file and a problem instance file.

13. The temporal planning system of claim 12, wherein the problem domain file comprises a plurality of predicates and functions, a plurality of actions, a plurality of methods and a plurality of temporal constraints between subtasks in methods.

14. The temporal planning system of claim 12, wherein the problem instance file comprises a plurality of temporal constraints and a plurality of objective tasks or goals.

15. The temporal planning system of claim 11, wherein the temporal planning problem comprises an initial model, at least one action and at least one constraint.

16. The temporal planning system of claim 11, wherein the temporal logic is applied via at least one search algorithm.

17. The temporal planning system of claim 16, wherein the expressed problem comprises at least one task, and wherein the at least one search algorithm decomposes the at least one task.

18. The temporal planning system of claim 16, wherein the expressed problem comprises at least one goal, and wherein the at least one search algorithm finds a path to the at least one goal model.

19. The temporal planning system of claim 17, wherein the at least one search algorithm comprises an AND/OR search.

20. The temporal planning system of claim 11, wherein the temporal planning language expresses high order temporal constraints with multiple nested modalities.

21. The temporal planning system of claim 19, wherein the high order temporal constraints comprise discrete and continuous variables.

22. The temporal planning system of claim 11, wherein the expressed problem comprises a set of objective tasks to be performed or a set of goals to be achieved.

23. The temporal planning system of claim 21, wherein the instructions further cause the processor to modify the at least one solution based on an additional objective task being added to the expressed problem as an additional objective task to be performed.

24. The temporal planning system of claim 21, wherein the instructions further cause the processor to modify the at least one solution based on at least one objective task from the set of objective tasks being removed.

25. The temporal planning system of claim 22, wherein the instructions further cause the processor to modify the at least one solution based on at least one action from the set of actions being invalidated.
